(19) United States
(12) Patent Application Publication
(10) Pub. No.: US 2026/0233581 A1
(43) Pub. Date: Aug. 13, 2026

(54) VEHICLE FLUID HEATING DEVICE

(71) Applicant: Panasonic Automotive Systems Co., Ltd., Kanagawa (JP)

(72) Inventors: Masato MORIKAWA, Shiga (JP); Atsushi HIROTA, Shiga (JP); Masaki HANADA, Aichi (JP)

(73) Assignee: Panasonic Automotive Systems Co., Ltd., Kanagawa (JP)

(21) Appl. No.: 19/450,186

(22) Filed: Jan. 15, 2026

(30) Foreign Application Priority Data
Feb. 13, 2025 (JP) 2025-021383

(51) Int. Cl. B60H 1/22; H05B 3/48

(52) U.S. Cl. CPC B60H 1/2221; H05B 3/48

(57) ABSTRACT

A vehicle fluid heating device includes: a tank including a flow path inside for directing a fluid; a heating unit that heats the fluid by heating the tank; a thermal interface material sandwiched between the tank and the heating unit; and a substrate having lower thermal conductivity than the tank. The heating unit includes one face on a thermal interface material side and an opposing other face on which the substrate is stacked, where the opposing other face is on the opposite side of the thermal interface material side. The heating unit and the substrate form a convex face that is curved to approach the tank.

### CROSS REFERENCE TO RELATED APPLICATION

The present application is based on and claims priority of Japanese Patent Application No. 2025-021383 filed on Feb. 13, 2025.

### FIELD

The present disclosure relates to vehicle fluid heating devices.

### BACKGROUND

Patent Literature (PTL) 1 discloses a vehicle heating device for heating a liquid such as water or liquid coolant. The vehicle heating device includes: a heating plate having a stainless steel substrate and dissipating elements disposed on the surface of the stainless steel substrate; and an aluminum heat-dissipating member disposed between a flow path and the heating plate.

### CITATION LIST

### PATENT LITERATURE

PTL 1: US Patent Application Publication No. 2020/0317027, the Specification

### SUMMARY

The vehicle heating device according to PTL 1 can be improved upon.

In view of this, the present disclosure provides a vehicle fluid heating device capable of improving upon the above related art.

A fluid heating device according to one aspect of the present disclosure includes: a tank including a flow path inside for directing a fluid; a heating unit that heats the fluid by heating the tank; a thermal interface material sandwiched between the tank and the heating unit; and a substrate having lower thermal conductivity than the tank. The heating unit includes one face on a thermal interface material side and an opposing other face on which the substrate is stacked, where the opposing other face is on the opposite side of the thermal interface material side. The heating unit and the substrate form a convex face that is curved to approach the tank.

The vehicle fluid heating device according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view of the tank and case of a vehicle fluid heating device according to an embodiment.

FIG. 2 is an exploded perspective view of the tank, thermal interface materials, heating units, and substrates of the vehicle fluid heating device according to the embodiment.

FIG. 3A is a cross-sectional view of, for instance, the tank, thermal interface materials, heating units, and substrates of the vehicle fluid heating device taken at line A-A in FIG. 1.

FIG. 3B is a cross-sectional view of, for instance, the tank, thermal interface materials, heating units, and substrates of the vehicle fluid heating device taken at line B-B in FIG. 1.

FIG. 4 is a diagram illustrating a heating unit and a substrate before and after molding.

FIG. 5 is a cross-sectional view of, for instance, the tank, heating elements, terminals, and wirings of the vehicle fluid heating device taken at line C-C in FIG. 1.

FIG. 6A is a perspective view of the vehicle fluid heating device according to the embodiment.

FIG. 6B is a cross-sectional view of, for instance, the tank, thermal interface materials, heating units, and substrates of the vehicle fluid heating device taken at line D-D in FIG. 6A.

FIG. 7 is a plan view schematically illustrating a case where the other end of a heating unit is trapezoidal in shape.

FIG. 8 is a plan view illustrating a case where a cutout portion is formed in the tank.

### DESCRIPTION OF EMBODIMENT

Hereinafter, an embodiment will be described in detail with reference to the drawings.

It should be noted that the embodiment described below shows a general or specific example of the present disclosure. The numerical values, shapes, materials, elements, the arrangement and connection of the elements, etc. shown in the following embodiment are examples, and are not intended to limit the present disclosure. Among the elements in the following embodiment, elements that are not described in independent claims will be described as arbitrary elements.

The figures are schematic diagrams and are not necessarily precise illustrations. In the figures, elements that are essentially the same share like reference numerals.

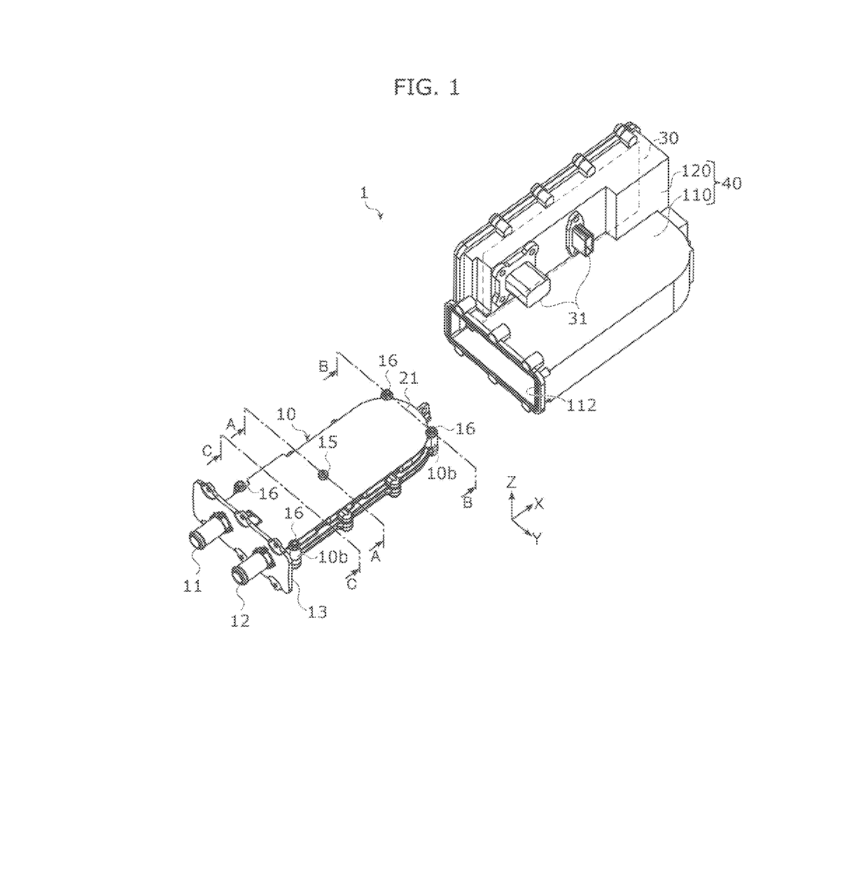

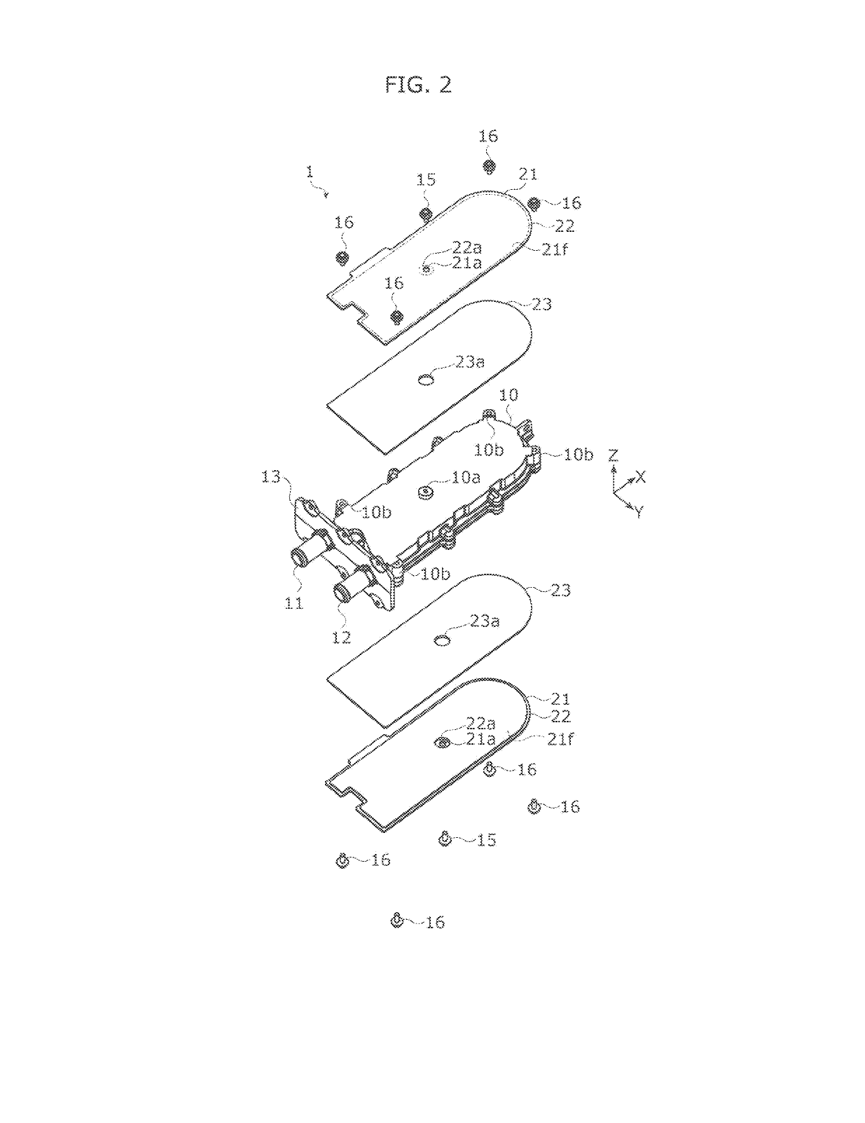

In the embodiment described below, in FIG. 1, a positive X-axis direction is defined as a direction in which the tank is inserted into the first opening, a positive Y-axis direction is defined as the direction of the circuit board relative to the cover, and a positive Z-axis direction is defined as a direction perpendicular to the positive X-axis direction and the positive Y-axis direction, and is also defined as the direction of the second housing relative to the first housing. The directions in FIG. 1 may be applied to FIG. 2 and the subsequent figures.

In the embodiment described below, the expressions such as “X-axis direction” and “trapezoidal” are used. For example, “X-axis direction” does not only mean being perfectly X-axis direction, but also means being substantially X-axis direction, and “trapezoidal” does not only mean being perfectly trapezoidal, but also means being substantially trapezoidal. In other words, each of these expressions means a state including an error of, for example, approximately several percent. In addition, “X-axis direction” and “trapezoidal” respectively mean being X-axis direction and being trapezoidal to the extent that the effects of the present disclosure can be achieved. The same applies to expressions using other directions and shapes.

### Embodiment

First, the configuration of vehicle fluid heating device 1 will be described with reference to FIGS. 1 through 8.

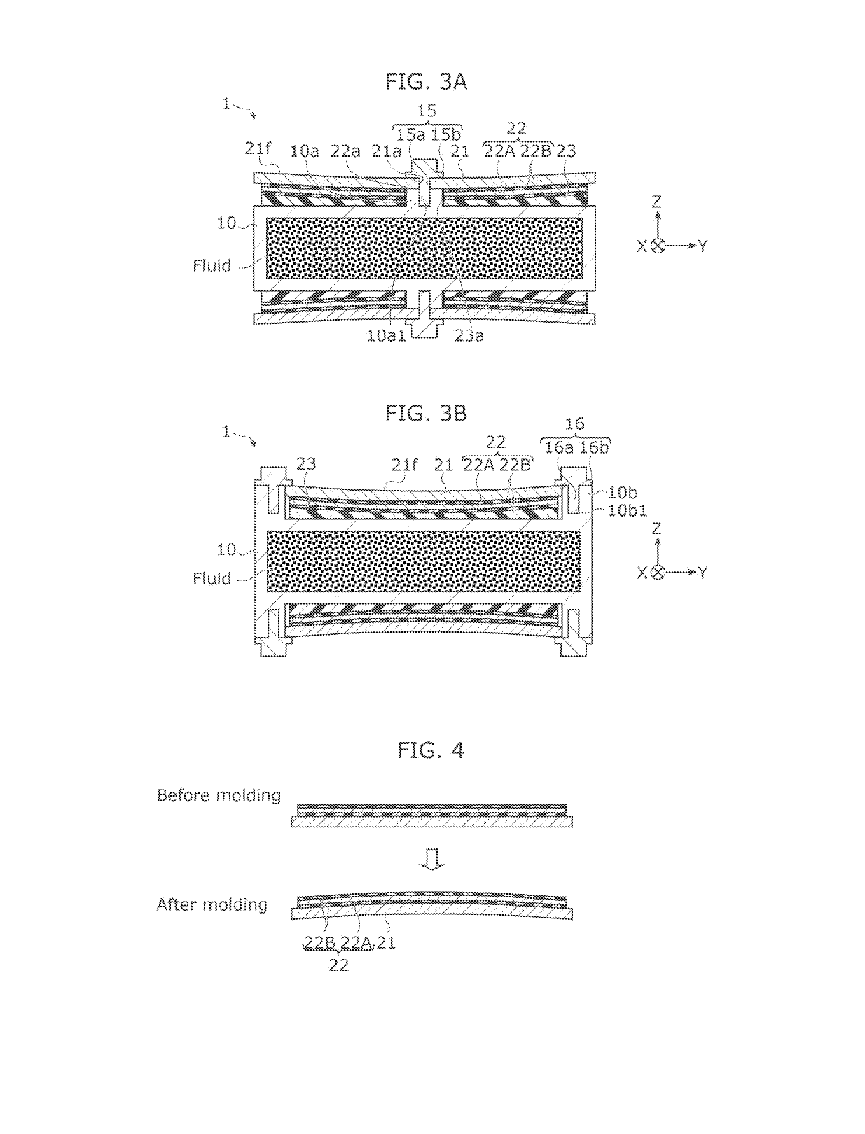

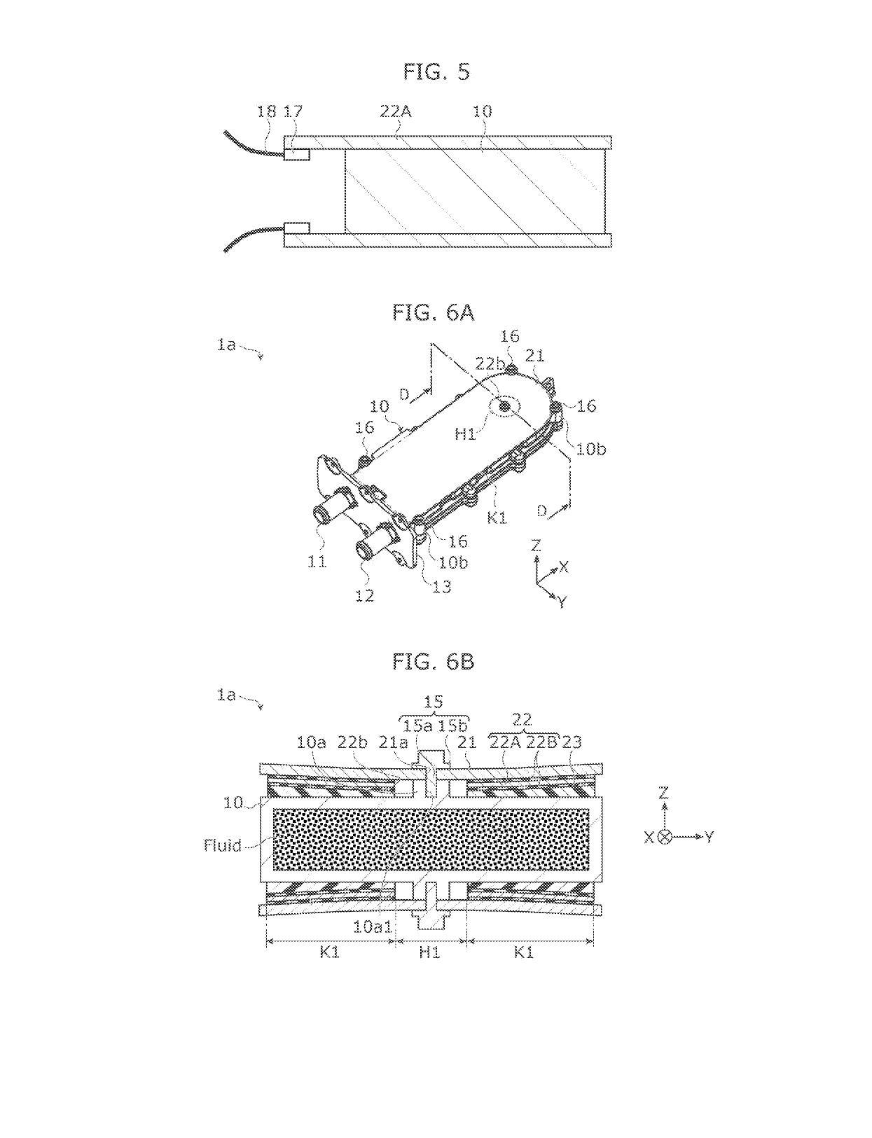

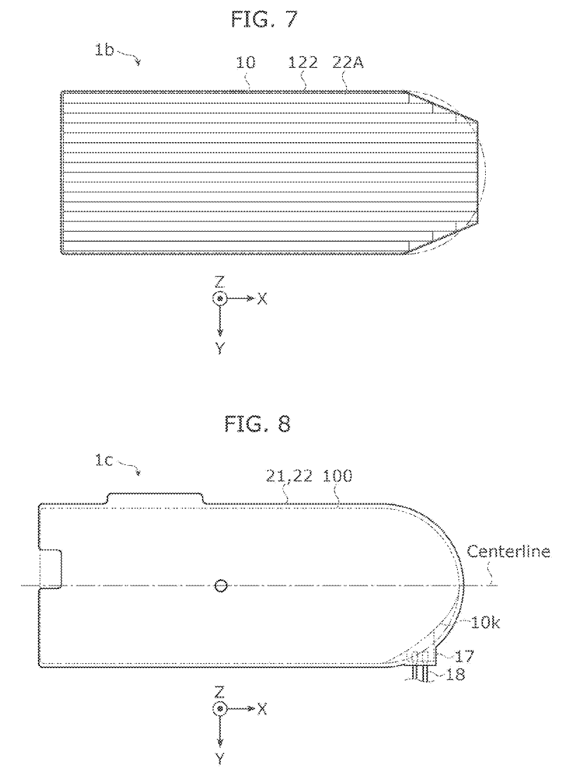

FIG. 1 is a perspective view of tank 10 and case 40 of vehicle fluid heating device 1 according to an embodiment. FIG. 2 is an exploded perspective view of, for instance, tank 10, thermal interface materials 23, heating units 22, and substrates 21 of vehicle fluid heating device 1 according to the embodiment. FIG. 3A is a cross-sectional view of, for instance, tank 10, thermal interface materials 23, heating units 22, and substrates 21 of vehicle fluid heating device 1 taken at line A-A in FIG. 1. FIG. 3B is a cross-sectional view of tank 10, thermal interface materials 23, heating units 22, and substrates 21 of vehicle fluid heating device 1 taken at line B-B in FIG. 1. FIG. 4 is a diagram illustrating heating unit 22 and substrate 21 before and after molding. FIG. 5 is a cross-sectional view of tank 10, heating elements 22A, terminals 17, and wirings 18 of vehicle fluid heating device 1 taken at line C-C in FIG. 1. In FIG. 5, thermal interface materials 23, substrates 21, and so on are omitted to suppress the complication of the drawing. FIG. 6A is a perspective view of vehicle fluid heating device 1 according to the embodiment. FIG. 6B is a cross-sectional view of, for instance, tank 10, thermal interface materials 23, heating units 22, and substrates 21 of vehicle fluid heating device 1 taken at line D-D line in FIG. 6A. FIG. 7 is a plan view schematically illustrating a case where the other end of heating unit 22 and the other end of tank 10 are trapezoidal in shape. FIG. 8 is a plan view illustrating a case where cutout portion 10k is formed in tank 100. In FIG. 8, to make cutout portion 10k of tank 100 visible, a line representing the other side of tank 100, which is symmetrical relative to the centerline, is indicated by a dashed-dotted line. In FIG. 8, the illustration of elements other than heating unit 22, substrate 21, terminal 17, and wirings 18 are omitted to suppress the complication of the drawing.

As illustrated in FIG. 1, vehicle fluid heating device 1 is applied to, for instance, vehicle batteries and vehicle air conditioning devices that are installed in vehicles such as electric vehicles (EVs), hybrid electric vehicles (HEVs), and plug-in hybrid electric vehicles (PHEVs). When applied to a vehicle air conditioning device, for example, vehicle fluid heating device 1 heats a fluid when the vehicle air conditioning device operates in a heating mode. This enables the vehicle air conditioning device to send warm air into the vehicle cabin.

As illustrated in FIGS. 1 and 2, vehicle fluid heating device 1 includes case 40, tank 10, thermal interface materials 23, heating units 22, substrates 21, and circuit board 30.

Case 40 houses tank 10, heating units 22, and circuit board 30. Case 40 is elongated in the X-axis direction and is L-shaped when viewed along the X-axis direction. Case 40 is made of, for example, metallic materials.

Specifically, case 40 includes: first housing 110 that is elongated in the X-axis direction and houses tank 10 elongated in the X-axis direction; and second housing 120 that extends in the Z-axis direction intersecting first housing 110 in the state of being coupled to first housing 110.

First housing 110 is flat in the Z-axis direction and elongated in the X-axis direction so as to house tank 10. In other words, first housing 110 is a container arranged parallel to the XY plane.

First housing 110 includes first opening 112 formed in one end portion in the longitudinal direction. First opening 112 opens so that tank 10 is insertable. First opening 112 is positioned on the negative X-axis direction side of first housing 110. It is therefore possible to insert tank 10 into first opening 112 of first housing 110 along the positive X-axis direction.

Second housing 120 is elongated along the longitudinal direction (the X-axis direction) of tank 10. Connectors 31 for electrical connection to circuit board 30 are attached to second housing 120.

Tank 10 inserted from first opening 112 includes lid 13 arranged to cover first opening 112. Lid 13 is fastened to first opening 112 by a fastening portion. Lid 13 is a plate-like member arranged at the end portion on the negative X-axis direction side of tank 10. Lid 13 is held at one end of tank 10 (on the negative X-axis direction side) so as to be parallel to the YZ plane.

Lid 13 is provided with supply port 11 and discharge port 12. In other words, supply port 11 and discharge port 12 are arranged at one end of tank 10. Supply port 11 and discharge port 12 are arranged close to each other so that they are aligned. A hose through which a fluid flows in is connected to supply port 11, and a hose through which a fluid flows out is connected to discharge port 12.

As illustrated in FIG. 2, tank 10 is flat and elongated. Specifically, tank 10 is a container that is flat in the Z-axis direction and elongated in the X-axis direction. In other words, tank 10 is a container shaped like a flat plate parallel to the XY plane. Tank 10 is made of, for example, metallic materials such as aluminum.

Tank 10 includes a flow path inside for directing a fluid. Specifically, tank 10 includes: supply port 11 through which a fluid is supplied from outside to the inside of tank 10; and discharge port 12 that discharges, to outside, a fluid that has passed through the flow path of tank 10. Supply port 11 and discharge port 12 are arranged on lid 13 of tank 10 to be aligned along the Y-axis direction. Each of supply port 11 and discharge port 12 is a connection port connectable to a hose not shown in the figure. With the hose being connected to each of supply port 11 and discharge port 12, a fluid can pass through the flow path of tank 10. The fluid is, for example, a liquid such as coolant.

Lid 13 is arranged at an end portion on the negative X-axis direction side of tank 10 and is integrated with tank 10. The integration means that lid 13 and tank 10 cannot be separated without destroying lid 13 and tank 10.

As illustrated in FIGS. 2 and 3A, thermal interface material 23, heating unit 22, and substrate 21 are arranged on each of one face of tank 10 on the positive Z-axis direction side of tank 10 and the other face of tank 10 on the negative Z-axis direction side of tank 10.

Specifically, thermal interface material 23, heating unit 22, and substrate 21 are stacked in this order on tank 10.

Thermal interface material 23 is sandwiched between tank 10 and heating unit 22 and is configured to be capable of transmitting heat generated by heating unit 22 to tank 10. The thermal conductivity of thermal interface material 23 may be higher than that of substrate 21.

Thermal interface material 23 is, for example, a heat transfer material for which silicon is used. In this case, thermal interface material 23 is in the form of paste applied to each of one face of tank 10 on the positive Z-axis direction side of tank 10 and the other face of tank 10 on the negative Z-axis direction side of tank 10. Thermal interface material 23 is a layered member stacked on tank 10, and is stacked on both faces (one face and the other face) of tank 10 to form a shape corresponding to the outer shape of tank 10.

Heating unit 22 is a layered member and is stacked on the surface of thermal interface material 23. Heating unit 22 forms a shape corresponding to the outer shape of tank 10. Heating unit 22 is sandwiched between substrate 21 and thermal interface material 23. Heating unit 22 can heat tank 10 through thermal interface material 23 by generating heat. With this, when a fluid supplied from supply port 11 of tank 10 passes through tank 10, the fluid is heated by heating unit 22, allowing the heated fluid to be discharged from discharge port 12.

Heating unit 22 includes heating element 22A and insulating layers 22B that sandwich heating element 22A.

Heating element 22A is, for example, heater wiring (not shown in the figure) that is patterned, and generates heat using power supplied from circuit board 30. Insulating layer 22B is stacked on the thermal interface material 23 side and the substrate 21 side of heating element 22A to sandwich heating element 22A. Insulating layer 22B is, for example, a glass paste containing glass, or the like. It is therefore possible to configure heating unit 22 so that neither heating element 22A and tank 10 nor heating element 22A and substrate 21 are electrically conductive.

Substrate 21 is a stacked layered member and is stacked on the other face of heating unit 22 on the opposite side of one face of heating unit 22 on the thermal interface material 23 side. Substrate 21 forms a shape corresponding to the outer shape of tank 10. Substrate 21 is made of, for example, a heat-resistant material such as stainless steel. The thermal conductivity of substrate 21 is lower than that of tank 10. As a result, when heating unit 22 generates heat, the heat is more readily transferred to the tank 10 side than to the substrate 21 side.

Surface 21f of substrate 21 on the opposite side of the heating unit 22 side may be mirror-finished. In this case, compared to a substrate whose surface is not mirror-finished, the amount of radiation from surface 21f of substrate 21 decreases. It is therefore possible to suppress an increase in heat dissipation from substrate 21 toward the side opposite to the heating unit 22 side. It should be noted that the glossiness of surface 21f when surface 21f is mirror-finished is greater than or equal to 50 GU.

Heating unit 22 and substrate 21 are configured integrally. Specifically, as illustrated in FIG. 4, first, after forming insulating layer 22B by applying and baking glass paste on substrate 21, patterned heater wiring is laminated and baked onto the surface of insulating layer 22B that has been formed. After that, by forming heating element 22B by further applying and baking glass paste to cover the heater wiring, a member in which heating unit 22 and substrate 21 are integrated can be obtained. Here, substrate 21 has, as a property, a greater coefficient of thermal expansion and contraction than insulating layer 22B and heating unit 22. For this reason, when heating unit 22 is baked onto substrate 21 and is molded, the center portion of heating unit 22 and the center portion of substrate 21 curve since substrate 21 is contracted more than heating unit 22. Since heating unit 22 and substrate 21 are stacked on thermal interface material 23, the center portion of substrate 21 and the center portion of heating unit 22 curve to approach tank 10 and the outer edge portion of substrate 21 and the outer edge portion of heating unit 22 excluding the center portions curve upward away from tank 10.

In other words, as illustrated in FIGS. 3A 3B, the center portion of heating unit 22 and the center portion of substrate 21 are curved upward to form a convex face protruding in the direction of tank 10. Therefore, the thickness of the center portion of thermal interface material 23 is less than the thickness of the outer edge portion of thermal interface material 23. It should be noted that FIGS. 3A and 3B show the warping of heating unit 22 and substrate 21 exaggerated for clarity, making the warping appear greater than it actually is.

A stacked body including these substrate 21, heating unit 22, and thermal interface material 23 is stacked on both faces of tank 10 and fixed to tank 10 by fixing member 15.

Specifically, tank 10 includes boss 10a to which fixing member 15 is coupled. Boss 10a is positioned in the center portion of each of one face (e.g., the face on the positive Z-axis direction side) of tank 10 and the other face (e.g., the face on the negative Z-axis direction side) of tank 10. Through-hole 22a that corresponds to boss 10a and is for inserting boss 10a is formed in heating unit 22. Since thermal interface material 23 is applied on one face and the other face of tank 10 to avoid boss 10a, hole 23a corresponding to through-hole 22a of heating unit 22 is formed in thermal interface material 23. Hole 21a corresponding to through-hole 22a of heating unit 22 is formed in substrate 21. Hole portion 21a of substrate 21 is placed on boss 10a.

Hole portion 21a, through-hole 22a, and hole 23a correspond to fastening hole 10a1 formed in boss 10a for coupling fixing member 15 to boss 10a. Fixing member 15 is a screw, bolt, or the like, and is coupled to boss 10a by being fastened to fastening hole 10a1 of boss 10a. In this case, fixing member 15 includes threaded portion 15a that is fastened to fastening hole 10a1 of boss 10a and flange-shaped head portion 15b protruding radially with respect to threaded portion 15a. With fixing member 15 being fastened to each of fastening holes 10a1 of the plurality of bosses 10a provided on both faces of tank 10, the stacked body can be secured with head portion 15b pressed against tank 10. As a result, the center portion of the stacked body is pressed to approach tank 10 by fixing member 15 coupled to tank 10.

Furthermore, tank 10 includes a plurality of bosses 10b to which fixing members 16 arranged along the outer edge portion of the stacked body are coupled.

Fixing member 16 is a screw, bolt, or the like, and is coupled to boss 10b by being fastened to fastening hole 10b1 of boss 10b. In this case, fixing member 16 includes threaded portion 16a that is fastened to fastening hole 10b1 of boss 10b and flange-shaped head 16b protruding radially with respect to threaded portion 16a. By being fastened to each fastening hole 10b1 of the plurality of bosses 10b provided on both faces of tank 10, fixing member 16 can be secured with head portion 16b pressed against tank 10. As a result, the outer edge portion of the stacked body is pressed to approach tank 10 by fixing member 16 coupled to tank 10. Fixing member 16 may be a bracket.

As illustrated in FIG. 5, heating element 22A of heating unit 22 is electrically connected to terminal 17. Terminal 17 is arranged at the edge of heating unit 22 in a position that is spaced apart from tank 10 by a predetermined distance not to contact tank 10. Terminal 17 is electrically connected to circuit board 30 via wiring 18.

As illustrated in FIG. 1, tank 10 is provided with heating unit 22, but when tank 10 is housed in first housing 110, a heat insulating layer is formed between heating unit 22 and the inner wall of first housing 110. The heat insulating layer is, for example, an air layer, a heat insulating material, or the like disposed between heating unit 22 and the inner wall of first housing 110. Heating unit 22 and first housing 110 are spaced apart from each other so as not to come into contact with each other.

Circuit board 30 is a plate elongated in the X-axis direction and is held in case 40 to be parallel with the XZ plane. Circuit board 30 housed in case 40 is disposed so as to extend from first housing 110 over second housing 120. Circuit board 30 can drive and control heating unit 22. Circuit board 30 can adjust, for instance, the temperature and heating duration of a fluid in tank 10 by driving and controlling heating unit 22.

Furthermore, as illustrated in FIGS. 6A and 6B, heated region K1 in which heating unit 22 is disposed and non-heated region H1 in which heating unit 22 is not disposed may be formed on the surface of tank 10 in vehicle fluid heating device 1a. In this case, non-heated region H1 may be positioned at the other end (on the positive X-axis direction side) of tank 10.

In this case, in non-heated region H1, substrate 21 may be stacked or boss 10a may be arranged. Substrate 21 may be fixed to tank 10 by fixing member 15 and boss 10a, which are disposed in non-heated region H1, being coupled to each other.

Furthermore, as illustrated in FIG. 7, in vehicle fluid heating device 1b, the outer shape of heating unit 122 positioned at the other end of tank 10 indicated by the broken line may be trapezoidal as indicated by the thick line. In this case, the outer shape of tank 10 at the other end, like the outer shape of heating unit 122, may be also trapezoidal as indicated by the broken line.

Heating element 22A of heating unit 122 is composed of a plurality of elongated strip-like bodies extending in the X-axis direction. In this case, when the outer shape of the heating unit is semicircular as indicated by the dash-dot-dot line, for example, many gaps are formed between the outer shape of the heating unit and the heating element. As a result, the area in which the heating element is disposed decreases, and also, the area of the heating unit increases greatly.

As in the present embodiment, however, if the outer shape of heating unit 122 is trapezoidal, the number of gaps between the outer shape of heating unit 122 and heating element 22A can be reduced as much as possible. As a result, the area in which heating element 22A is disposed can be increased as much as possible and the enlargement of heating unit 122 can be inhibited. Therefore, when the outer shape of heating unit 122 is trapezoidal, it is possible to increase a density per unit area occupied by heating element 22A in heating unit 122 compared to when the outer shape of the heating unit is semicircular as indicated by the dash-dot-dot line in FIG. 7.

Terminal 17 may be disposed on the other side of tank 10. Terminal 17 is a connector for electrically connecting heating unit 122 and circuit board 30.

As illustrated in FIG. 8, cutout portion 10k formed by cutting out a part of tank 100 may be formed at the other edge of tank 100 in vehicle fluid heating device 1c. Since cutout portion 10k is formed in tank 100, the other end of tank 100 may have an asymmetrical shape with respect to the centerline of tank 100 extending in the longitudinal direction. In FIG. 8, a symmetrical shape with respect to the centerline of tank 100 is indicated by the dash-dot-dot line. The centerline is a line parallel to the X-axis direction. Terminal 17 may be disposed in cutout portion 10k.

### Operational Effects

Next, operational effects of vehicle fluid heating devices 1 through 1c according to the present embodiment will be described.

In the vehicle heating device according to PTL 1, heat generated by the heating element of the heating plate is transferred to the flow path via the stainless steel substrate and the aluminum heat-dissipating member. However, in a configuration using a stainless steel substrate with lower thermal conductivity than aluminum, there is a challenge in efficiently transmitting heat generated by the heating element to a fluid.

In view of this, vehicle fluid heating devices 1 through 1c according to Technique 1 of the present embodiment each include: tank 10, 100 including a flow path inside for directing a fluid; heating unit 22, 122 that heats the fluid by heating tank 10, 100; thermal interface material 23 sandwiched between tank 10, 100 and heating unit 22, 122; and substrate 21 having lower thermal conductivity than tank 10, 100. Heating unit 22, 122 includes one face on the thermal interface material 23 side and an opposing other face on which substrate 21 is stacked, where the opposing other face is on the opposite side of the thermal interface material 23 side. Heating unit 22, 122 and substrate 21 form a convex face that is curved to approach tank 10, 100, as described above.

According to this, since heating unit 22, 122 is curved to approach tank 10, 100, the structure is designed such that heating unit 22, 122 is positioned to approach tank 10, 100 by reducing the thickness of thermal interface material 23 corresponding to the curved portion of heating unit 22, 122. When heating unit 22, 122 generates heat, the heat is transferred to tank 10, 100 via thermal interface material 23 since substrate 21 has lower thermal conductivity than tank 10, 100.

Accordingly, these vehicle fluid heating devices 1 through 1c are capable of efficiently transmitting heat generated by heating unit 22, 122 to a fluid.

Vehicle fluid heating devices 1 through 1c according to Technique 2 of the present embodiment are vehicle fluid heating devices 1 through 1c according to Technique 1. In this case: thermal interface material 23 is a layered member stacked on tank 10, 100; heating unit 22, 122 is a layered member stacked on thermal interface material 23; the center portion of heating unit 22, 122 is curved to form a convex face in the direction of tank 10; and the thickness of the center portion of thermal interface material 23 is less than the thickness of the outer edge portion of thermal interface material 23.

According to this, the thickness of the central portion of thermal interface material 23 can be reduced, allowing the central portion of heating unit 22, 122 to approach tank 10, 100. By reducing the thickness of the central portion of thermal interface material 23, an increase in thermal resistance on tank 10, 100 side is suppressed and the amount of heat dissipated to tank 10, 100 increases, thereby suppressing the temperature rise of heating unit 22, 122. Consequently, heating unit 22, 122 is prevented from being overheated. As a result, this prevents heating unit 22, 122 from generating heat beyond the heat resistance temperature of heating unit 22, 122 as well as the heat resistance temperature of thermal interface material 23.

Moreover, during assembly of vehicle fluid heating devices 1 through 1c, when heating unit 22, 122, which has a convex face, is pressed against thermal interface material 23 stacked on tank 10, 100, air between thermal interface material 23 and heating unit 22, 122 can be expelled from the central portion of heating unit 22, 122 toward the exterior. Consequently, it becomes difficult for an air layer to be formed between thermal interface material 23 and heating unit 22, 122. As a result, the heat generated by heating unit 22, 122 is more readily transferred to tank 10, 100, enabling more efficient heat transfer to the fluid in tank 10, 100.

Vehicle fluid heating devices 1 through 1c according to Technique 3 of the present embodiment are vehicle fluid heating devices 1 through 1c according to Technique 1 or 2. In this case: substrate 21 is a layered member stacked on heating unit 22, 122; and the outer edge portion of a stacked body including substrate 21, heating unit 22, 122, and thermal interface material 23 is pressed by fixing member 15, 16 coupled to tank 10, 100 to cause the outer edge portion to approach tank 10, 100.

According to this, substrate 21 and heating unit 22, 122 can be prevented from floating up from tank 10, 100. Consequently, heat generated by heating unit 22, 122 is more readily transferred to tank 10, 100, enabling more efficient heat transfer to a fluid in tank 10, 100.

Moreover, since fixing member 16 fixes the outer edge portion of the stacked body to tank 10, 100, it is possible to suppress an increase in the number of fixing points required to fix the central portion of the stacked body to tank 10, 100. Consequently, to the extent that the increase in the number of fixing points in the central portion is suppressed, it is possible to suppress a large increase in the area of heating unit 22, 122.

Vehicle fluid heating devices 1 through 1c according to Technique 4 of the present embodiment are vehicle fluid heating devices 1 through 1c according to any one of Techniques 1 to 3. In this case, the thermal expansion coefficient of substrate 21 is greater than the thermal expansion coefficient of heating unit 22, 122.

According to this, when substrate 21 and heating unit 22, 122 are molded integrally through high-temperature processing, substrate 21 with a larger thermal expansion coefficient contracts more than heating unit 22, 122 during cooling, resulting in the formation of a convex face in the central portion of heating unit 22, 122.

Vehicle fluid heating devices 1 through 1c according to Technique 5 of the present embodiment are vehicle fluid heating devices 1 through 1c according to any one of Techniques 1 to 4. In this case: heating unit 22, 122 includes heating element 22A and insulating layers 22B that sandwich heating element 22A; and the thermal expansion coefficient of substrate 21 is greater than the thermal expansion coefficient of insulating layers 22B.

According to this, when substrate 21 and heating unit 22, 122 are molded integrally through high-temperature processing, substrate 21 with a larger thermal expansion coefficient contracts more than insulating layers 22B of heating unit 22, 122 during cooling, resulting in the formation of a convex face in the central portion of heating unit 22, 122.

Vehicle fluid heating devices 1 through 1c according to Technique 6 of the present embodiment are vehicle fluid heating devices 1 through 1c according to any one of Techniques 1 to 5. In this case: tank 10, 100 includes boss 10a coupled to fixing member 15; boss 10a is formed in the center portion of tank 10, 100; and the center portion of a stacked body including substrate 21, heating unit 22, 122, and thermal interface material 23 is pressed by fixing member 15 coupled to boss 10a to cause the center portion to approach tank 10, 100.

According to this, when thermal interface material 23 is applied to tank 10, 100, even when thermal interface material 23 is applied to the surface of boss 10a, thermal interface material 23 between boss 10a and substrate 21 can be pushed outward when fixing the stacked body to tank 10, 100 by fixing member 15. Consequently, when fixing member 15 is coupled to boss 10a, the coupling between fixing member 15 and boss 10a can be prevented from loosening due to thermal interface material 23.

Moreover, since the thickness of the heat transfer component is reduced in the center portion, there is a possibility that the heating unit and the tank may come into contact with each other, potentially damaging the insulating layers of the heating unit.

According to the present embodiment, however, since boss 10a is positioned in the center portion of tank 10, 100, insulating layers 22B can be prevented from excessively approaching tank 10, 100, thereby suppressing damage to insulating layers 22B.

Fluid heating devices 1 through 1c according to Technique 7 of the present embodiment are vehicle fluid heating devices 1 through 1c according to any one of Techniques 1 to 6. In this case, surface 21f of substrate 21 on the opposite side of heating unit 22, 122 side is mirror finished.

According to this, the emissivity of the surface of substrate 21 decreases, which can reduce the amount of radiant energy.

Vehicle fluid heating device 1a according to Technique 8 of the present embodiment is vehicle fluid heating device 1a according to any one of Techniques 1 to 7. In this case, tank 10, 100 is elongated, tank 10, 100 includes: supply port 11 through which the fluid is supplied to tank 10, 100 from outside; and discharge port 12 through which the fluid that has passed through the flow path of tank 10, 100 is discharged to the outside. Supply port 11 and discharge port 12 are disposed on one side of tank 10, 100. Heated region K1 in which heating unit 22, 122 is stacked and non-heated region H1 in which heating unit 22, 122 is not stacked are formed in tank 10, 100, and non-heated region H1 is located on the other side of tank 10, 100.

For example, since part of a fluid that flows in through the supply port flows out to the discharge port at one end of the tank without reaching the other end of the tank, there is a tendency that the fluid is more likely to stay, the temperature of the heating unit rises, and the temperature of the fluid also rises easily.

According to the present embodiment, however, since non-heated region H1 is arranged at the other end of tank 10, 100, it is possible to equalize the temperature of heating unit 22, 122, thereby suppressing an increase in fluid temperature at the other end of tank 10, 100 and making the fluid temperature in tank 10, 100 more uniform.

Vehicle fluid heating device 1a according to Technique 9 of the present embodiment is vehicle fluid heating device 1a according to Technique 8. In this case, in non-heated region H1, a stacked body including substrate 21, heating unit 22, 122, and thermal interface material 23 is fixed to tank 10, 100 by fixing member 15.

According to this, in non-heated region H1, since fixing member 15 can secure the stacked body to tank 10, 100, the enlargement of heating unit 22, 122 can be suppressed by the amount corresponding to the fixing points provided by fixing members 15.

Particularly, since boss 10a can also be arranged in non-heated region H1, in this case, the enlargement of heating unit 22, 122 can be suppressed by the amount corresponding to boss 10a.

Vehicle fluid heating device 1b according to Technique 10 of the present embodiment is vehicle fluid heating device 1b according to any one of Techniques 1 to 9. In this case, the outer shape of heating unit 122 positioned at the other end of tank 10 is trapezoidal, and the outer shape of tank 10 at the other end of tank 10 is also trapezoidal.

According to this, since heating element 22A can be arranged in accordance with the outer shapes of heating unit 122 and tank 10, heating element 22A can be arranged with as little gap as possible. As a result, the enlargement of heating unit 122 and tank 10 can be suppressed.

Vehicle fluid heating device 1c according to Technique 11 of the present embodiment is vehicle fluid heating device 1c according to any one of Techniques 1 to 10. In this case: terminal 17 electrically connected to heating unit 22, 122 is disposed on the other side of tank 100; cutout portion 10k is formed on the other side of tank 100, where the cutout portion is formed by cutting out a part of tank 100; a portion on the other side of the tank is asymmetric in shape relative to the centerline of tank 100, where the centerline extends from one side of tank 100 toward the other side of tank 100; and terminal 17 is disposed in cutout portion 10k.

For example, generally speaking, terminals are arranged at a predetermined distance from the tank to prevent contact, which tends to increase the size of the heating unit accordingly.

According to the present embodiment, however, terminal 17 can be arranged in cutout portion 10k of tank 100, thereby suppressing the enlargement of heating unit 22, 122.

### Other Variations

Although a vehicle fluid heating device according to the present disclosure has been described based on the embodiment described above, the present disclosure is not limited to the embodiment. Other embodiments obtained by various modifications to the embodiment that may be conceived by persons skilled in the art may be also included in the range of the present disclosure so long as they do not depart from the essence of the present disclosure.

Other embodiments obtained by various modifications to the aforementioned embodiment that may be conceived by persons skilled in the art, as well as embodiments realized by combining elements and functions in the embodiment that do not depart from the essence of the present disclosure may be also included in the range of the present disclosure.

While various embodiments have been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims is incorporated herein by reference in their entirety: Japanese Patent Application No. 2025-021383 filed on Feb. 13, 2025.

### Industrial Applicability

The present disclosure can be used for vehicle fluid heating devices such as air conditioning devices installed in vehicles.

1. A vehicle fluid heating device comprising:
a tank including a flow path inside for directing a fluid;
a heating unit that heats the fluid by heating the tank;
a thermal interface material sandwiched between the tank and the heating unit; and
a substrate having lower thermal conductivity than the tank, wherein
the heating unit includes one face on a thermal interface material side and an opposing other face on which the substrate is stacked, the opposing other face being on an opposite side of the thermal interface material side, and
the heating unit and the substrate form a convex face that is curved to approach the tank.

2. The vehicle fluid heating device according to claim 1, wherein
the thermal interface material is a layered member stacked on the tank,
the heating unit is a layered member stacked on the thermal interface material,
a center portion of the heating unit is curved to form a convex face, and
a thickness of the center portion of the thermal interface material is less than a thickness of an outer edge portion of the thermal interface material.

3. The vehicle fluid heating device according to claim 1, wherein
the substrate is a layered member stacked on the heating unit, and
an outer edge portion of a stacked body including the substrate, the heating unit, and the thermal interface material is pressed by a fixing member coupled to the tank to cause the outer edge portion to approach the tank.

4. The vehicle fluid heating device according to claim 1, wherein
a thermal expansion coefficient of the substrate is greater than a thermal expansion coefficient of the heating unit.

5. The vehicle fluid heating device according to claim 1, wherein
the heating unit includes a heating element and insulating layers that sandwich the heating element, and
a thermal expansion coefficient of the substrate is greater than a thermal expansion coefficient of the insulating layers.

6. The vehicle fluid heating device according to claim 1, wherein
the tank includes a boss coupled to a fixing member,
the boss is formed in a center portion of the tank, and
a center portion of a stacked body including the substrate, the heating unit, and the thermal interface material is pressed by a fixing member coupled to the boss to cause the center portion to approach the tank.

7. The vehicle fluid heating device according to claim 1, wherein
a surface of the substrate on an opposite side of a heating unit side is mirror finished.

8. The vehicle fluid heating device according to claim 1, wherein
the tank is elongated,
the tank includes: a supply port through which the fluid is supplied to the tank from outside; and a discharge port through which the fluid that has passed through the flow path of the tank is discharged to the outside,
the supply port and the discharge port are disposed on one side of the tank,
a heated region in which the heating unit is stacked and a non-heated region in which the heating unit is not stacked are formed in the tank, and
the non-heated region is located on an other side of the tank.

9. The vehicle fluid heating device according to claim 8, wherein
in the non-heated region, a stacked body including the substrate, the heating unit, and the thermal interface material is fixed to the tank by a fixing member.

10. The vehicle fluid heating device according to claim 1, wherein
an outer shape of the heating unit positioned at an other end of the tank is trapezoidal, and
an outer shape of the tank at the other end of the tank is also trapezoidal.

11. The vehicle fluid heating device according to claim 1, wherein
a terminal electrically connected to the heating unit is disposed on an other side of the tank,
a cutout portion is formed on the other side of the tank, the cutout portion being formed by cutting out a part of the tank,
a portion on the other side of the tank is asymmetric in shape relative to a centerline of the tank, the centerline extending from one side of the tank toward the other side of the tank, and
the terminal is disposed in the cutout portion.
